(19) United States
(12) Patent Application Publication
(10) Pub. No.: US 2023/0268998 A1
(43) Pub. Date: Aug. 24, 2023

(54) OPTICAL TRANSMISSION SYSTEM AND DESIGN METHOD FOR OPTICALTRANSMISSION SYSTEM

(71) Applicant: Nippon Telegraph and Telephone Corporation, Tokyo (JP)

(72) Inventors: Kohei SAITO, Musashino-shi, Tokyo (JP); Takeshi SEKI, Musashino-shi, Tokyo (JP); Sachio SUDA, Musashino-shi, Tokyo (JP); Hiroki KAWAHARA, Musashino-shi, Tokyo (JP); Kenta HIROSE, Musashino-shi, Tokyo (JP); Hideki MAEDA, Musashino-shi, Tokyo (JP)

(21) Appl. No.: 18/012,461

(22) PCT Filed: Jul. 2, 2020
(86) PCT No.: PCT/JP2020/026088

§ 371 Date: Dec. 22, 2022

(51) Int. Cl. H04B 10/40; H04B 10/073

(52) U.S. Cl. CPC H04B 10/40; H04B 10/073

(57) ABSTRACT

Provided is an optical transmission system that includes: a transponder having a transmitter and a receiver; a loopback path that directly couples a signal of the transmitter to the receiver; and a server that calculates, based on a signal transmitted using the loopback path, a compensation value to compensate for frequency characteristics of a signal transmitted from the transmitter.

### CROSS-REFERENCE TO RELATED APPLICATIONS

This is a National Stage Application of PCT Application No. PCT/JP2020/026088, filed on Jul. 2, 2020. The disclosure of the prior application is considered part of the disclosure of this application, and is incorporated in its entirety into this application.

### TECHNICAL FIELD

The present disclosure relates to an optical transmission system and a method of designing the optical transmission system.

### BACKGROUND ART

An optical transmission system includes an optical transmission layer in which a plurality of nodes are interconnected by links. In such an optical transmission layer, photophysical properties and analog control properties interact in a complex manner, and a failure (abnormality) for which it is difficult to identify a failure (abnormal) position and a cause occurs.

In optical transmission systems, a digital coherent system including electric signal processing is employed for transmission and reception of optical signals. There is proposed a method of improving optical signal quality by utilizing implementable features of electric signal processing and using an electric signal processor to compensate for characteristics of an optical module (such as an optical modulator and an integrated coherent receiver (ICR)) used in a transmitter and a receiver and an electric module (such as a driver amplifier, a trans-impedance amplifier (TIA), and a high-frequency cable) (see NPLS 1 and 2).

### PRIOR ART DOCUMENT

### Non Patent Literature

NPL 1: A. Matsushita, et. al., “64-GBd PDM-256QAM and 92-GBd PDM-64QAM Signal Generation using Precise-Digital-Calibration aided by Optical-Equalization”, Proc. OFC2019, W4B.2.

NPL 2: A. Matsushita, et. al., “High-Spectral-Efficiency 600-Gbps/Carrier Transmission Using PDM-256QAM Format”, IEEE JLT, vol.37, no.2, Jan. 15, 2019.

### SUMMARY OF THE INVENTION

### Technical Problem

However, a plurality of variations of parameters and correction methods need to be set on a transmission end and a reception end, and thus, unfortunately, it is difficult to obtain an optimum design.

The present disclosure has been made in view of the above-described circumstances, and an object of the present disclosure is to optimally design frequency compensation in a transponder.

### Means for Solving the Problem

Regarding means for solving the problem described above, an aspect of the present disclosure is an optical transmission system including a transponder having a transmitter and a receiver, the optical transmission system including: a first path configured to directly couple a signal of the transmitter to the receiver; and a calculation device configured to calculate, based on a signal transmitted using the first path, a compensation value to compensate for frequency characteristics of a signal transmitted from the transmitter.

### Effects of the Invention

According to the present disclosure, it is possible to optimally design frequency compensation in a transponder.

### BRIEF DESCRIPTION OF DRAWINGS

FIG. 1 is a diagram illustrating a configuration of an optical transmission system according to a first embodiment of the present disclosure.

FIG. 2 is a diagram illustrating an example of a hardware configuration of a computer implementing a function of a server of the optical transmission system according to the first embodiment.

FIG. 3 is a graph showing an example of frequency characteristics of an electric module of the optical transmission system according to the first embodiment.

FIG. 4 is a graph showing an example of frequency characteristics of an electric signal of the optical transmission system according to the first embodiment.

FIG. 5 is a graph showing an example of frequency characteristics of a compensated signal of the optical transmission system according to the first embodiment.

FIG. 6 is a flowchart illustrating processing for designing the optical transmission system according to the first embodiment.

FIG. 7 is an optimization subroutine of the processing for designing the optical transmission system according to the first embodiment.

FIG. 8 is an explanatory diagram illustrating a relationship between a BER of the optical transmission system according to the first embodiment and a reference value.

FIG. 9 is a diagram illustrating a configuration of an optical transmission system according to a second embodiment of the present disclosure.

FIG. 10 is a flowchart illustrating processing for designing the optical transmission system according to the second embodiment.

FIG. 11 is a diagram illustrating a configuration of an optical transmission system according to a third embodiment of the present disclosure.

FIG. 12 is a flowchart illustrating processing for designing the optical transmission system according to the third embodiment.

FIG. 13 is a diagram illustrating a configuration of an optical transmission system according to a fourth embodiment of the present disclosure.

FIG. 14 is a diagram illustrating a configuration of an optical transmission system according to a fifth embodiment of the present disclosure.

FIG. 15 is a graph showing an optical signal spectrum of the optical transmission system according to the fifth embodiment.

FIG. 16 is a diagram illustrating a configuration of an optical transmission system according to a sixth embodiment.

FIG. 17 is a graph showing an optical signal spectrum of the optical transmission system according to the sixth embodiment.

### DESCRIPTION OF EMBODIMENTS

Optical transmission systems and the like according to modes for carrying out the present disclosure (hereinafter, referred to as “the present embodiment”) will be described below with reference to the drawings.

### First Embodiment

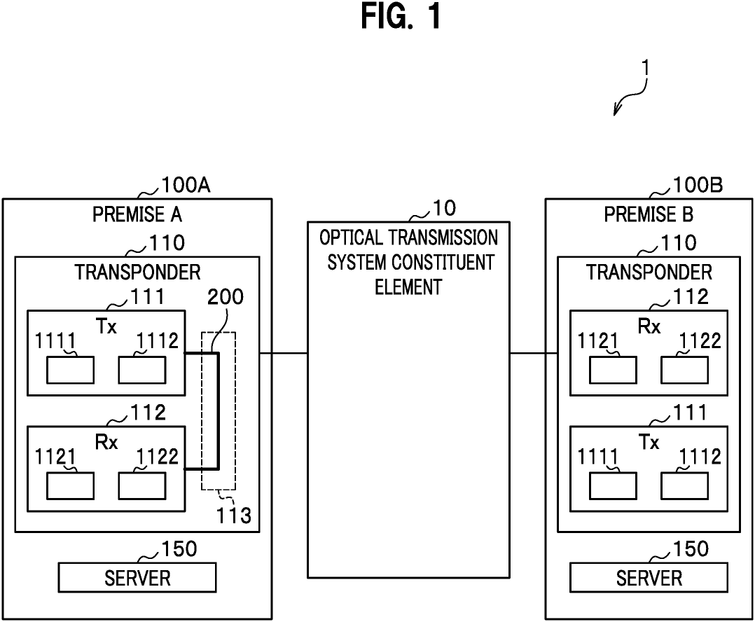

FIG. 1 is a diagram illustrating a configuration of an optical transmission system according to a first embodiment of the present disclosure.

As illustrated in FIG. 1, in an optical transmission system 1, a premise 100A (a first premise) and an premise 100B (a second premise) are connected via an optical transmission system constituent element 10 other than transponders.

The optical transmission system constituent element 10 includes an optical multiplexer and demultiplexer unit, an optical cross-connect device, an optical amplification and relay device, an optical fiber transmission path, and the like.

The premise 100A and the premise 100B each include a transponder 110 and a server 150 (calculation device).

The transponder 110 includes a transmitter (Tx) 111 and a receiver (Rx) 112. In addition, the transponder 110 of the premise 100A further includes a cross-connect function unit 113. However, the transponder 110 of the premise 100B may be configured to include the cross-connect function unit 113.

The transmitter (Tx) 111 includes an electric signal generator 1111 and an electric signal transmitter 1112.

The receiver (Rx) 112 includes an electric signal receiver 1121 and an electric signal generator 1122.

The cross-connect function unit 113 forms a loopback path 200 (first path) that directly couples a signal of the transmitter (Tx) 111 to the receiver (Rx) 112 of the same premise.

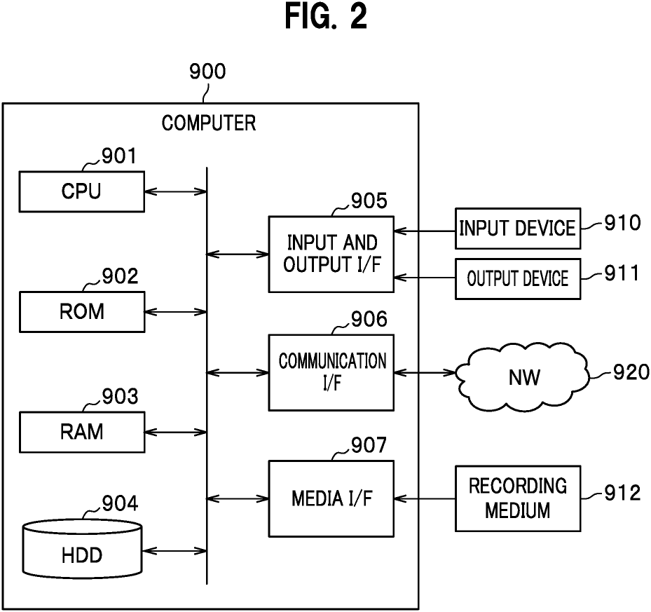

The server 150 of the optical transmission system 1 according to the present embodiment is implemented using a computer 900, which is a physical apparatus configured as illustrated in FIG. 2, for example.

FIG. 2 is a diagram illustrating an example of a hardware configuration of a computer implementing the function of the server 150 of the optical transmission system 1 according to the first embodiment of the present disclosure. The computer 900 includes a central processing unit (CPU) 901, a read only memory (ROM) 902, a RAM 903, a hard disk drive (HDD) 904, an input and output interface (I/F) 905, a communication I/F 906, and a media I/F 907.

The CPU 901 operates according to a program stored in the ROM 902 or the HDD 904 and performs control using a control section of the server 150 illustrated in FIG. 1. The ROM 902 stores a boot program to be executed by the CPU 901 when the computer 900 is activated, a program relating to hardware of the computer 900, and the like.

The CPU 901 controls an input device 910 such as a mouse and a keyboard and controls an output device 911 such as a display, via the input and output I/F 905. The CPU 901 acquires data from the input device 910 and outputs generated data to the output device 911, via the input and output I/F 905. A graphics processing unit (GPU) or the like may be used together with the CPU 901 as a processor.

The HDD 904 stores a program to be executed by the CPU 901, data used by the program, and the like. The communication I/F 906 receives data from another apparatus via a communication network (for example, a network (NW) 920), outputs the received data to the CPU 901, or transmits data generated by the CPU 901 to another apparatus via the communication network.

The media I/F 907 reads a program or data stored in a recording medium 912 and outputs the program or the data to the CPU 901 via the RAM 903. The CPU 901 loads, to the RAM 903, a program relating to intended processing from the recording medium 912 via the media I/F 907 and executes the loaded program. The recording medium 912 is an optical recording medium such as a digital versatile disc (DVD) and a phase change rewritable disk (PD), a magneto-optical recording medium such as a magneto optical disk (MO), a magnetic recording medium, a conductor memory tape medium, a semiconductor memory, or the like.

For example, in a case where the computer 900 functions as the server 150 of the optical transmission system 1 according to the present embodiment, the CPU 901 of the computer 900 executes a program loaded on the RAM 903 to embody the function of the server 150. In addition, the HDD 904 stores data in the RAM 903. The CPU 901 reads a program relating to the intended processing from the recording medium 912 and executes the program. In addition, the CPU 901 may read a program relating to the intended processing from another apparatus via the communication network (NW 920).

A method of designing the optical transmission system 1 configured as described above will be described below.

The following is a technical background to the application of the optical transmission system 1 to an optical communication system.

In the optical communication system, a digital coherent system including electric signal processing is utilized for transmission and reception of an optical signal. As it is possible to perform electric signal processing at high speed using a digital signal processor (DSP), the optical signal quality can be improved by using an electric signal processor to compensate for characteristics of an optical module (such as an optical modulator and an ICR) used in a transmitter and a receiver and an electric module (such as a driver amplifier, a TIA, and a high-frequency cable).

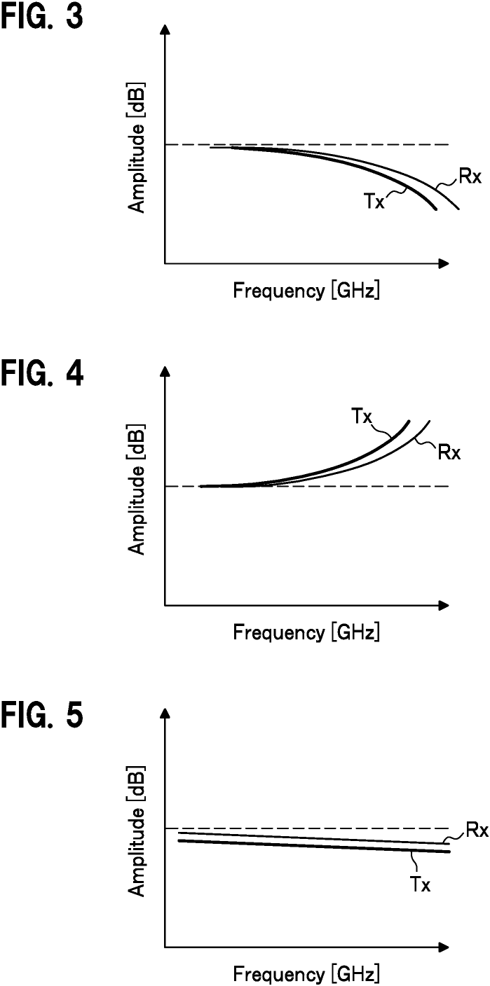

FIG. 3 is a graph showing an example of frequency characteristics of an electric module of an optical transmission system. The horizontal axis represents a frequency [GHz], and the vertical axis represents an amplification factor (amplitude [dB]). As shown in FIG. 3, it can be seen that the frequency characteristics of the electric module tend to be degraded as the frequency increases.

FIG. 4 is a graph showing an example of the frequency characteristics of an electric signal of an optical transmission system. The horizontal axis represents a frequency [GHz], and the vertical axis represents an amplification factor (amplitude [dB]).

When the frequency characteristics of the electric module shown in FIG. 3 are known, an electric signal having opposite characteristics shown in FIG. 4 can be provided to boost the high-frequency components.

FIG. 5 is a graph showing an example of frequency characteristics of a compensated signal. The horizontal axis represents a frequency [GHz], and the vertical axis represents an amplification factor (amplitude [dB]).

The frequency characteristics of the electric module shown in FIG. 3 are compensated for by providing a signal having the opposite characteristics shown in FIG. 4. As shown in FIG. 5, the electric module has flat frequency characteristics from a low frequency to a high frequency, and thus, the signal quality can be improved.

Based on the technical background described above, the frequency compensation by the optical transmission system 1 will be described with reference to a flowchart.

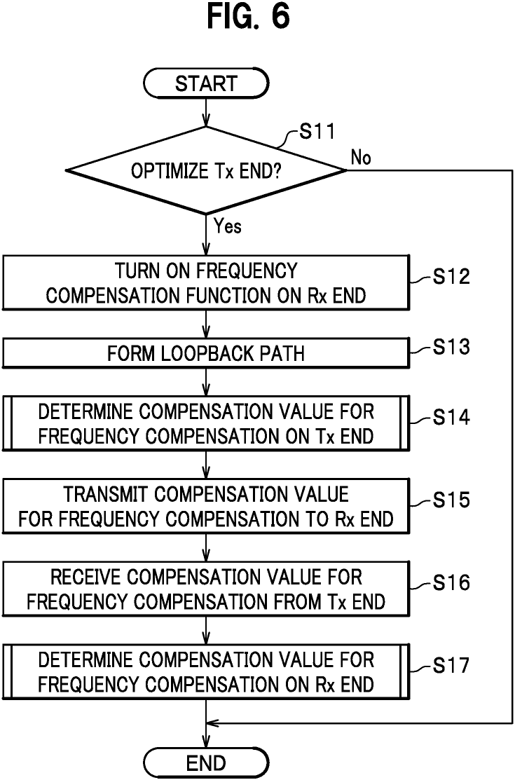

FIG. 6 is a flowchart illustrating processing for designing the optical transmission system 1. In the present processing flow, the control section of the server 150 controls each part of the transponder 110 (see FIG. 1).

In step S11, it is determined whether optimization on the transmitter (hereinafter, referred to as Tx) 111 end is to be performed.

When the optimization on the Tx 111 end is not to be performed, the processing of the present processing flow is terminated. Here, when the optimization on the Tx 111 end is to be performed, the frequency compensation on the receiver (hereinafter, referred to as Rx) 112 end is fixed. On the other hand, when optimization on the Rx 112 end is to be performed, the frequency compensation on the Tx 111 end is fixed.

When the optimization on the Tx 111 end is to be performed, the function of the electric signal receiver 1121 of the receiver (hereinafter, referred to as Rx) 112 is turned on in step S12 (in this case, the compensation value remains at an initial value).

In step S13, the cross-connect function unit 113 (see FIG. 1) of the transponder 110 switches a path to form the loopback path 200 (see FIG. 1). The loopback path 200 forms the loopback path 200 that feeds the transmission signal of the Tx 111 back to the Rx 112 of the same premise.

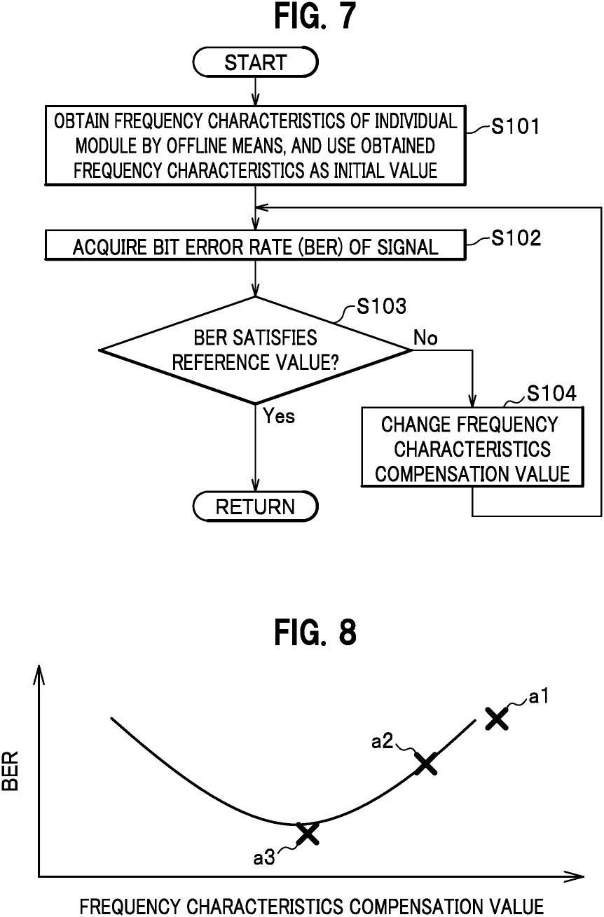

In step S14, the electric signal generator 1111 of the Tx 111 determines the compensation value for the frequency compensation (see the optimization subroutine in FIG. 7). The determined compensation value mainly compensates for the frequency characteristics of the Tx 111.

Thus, a signal having opposite characteristics in the frequency characteristics (see FIG. 4) can be set as the compensation value for the frequency compensation.

In step S15, the electric signal transmitter 1112 of the Tx 111 transmits the determined compensation value for the frequency compensation to the Rx 112 end via the loopback path 200.

In step S16, the electric signal receiver 1121 of the Rx 112 receives the compensation value for the frequency compensation determined on the Tx 111 end.

In step S17, the electric signal generator 1122 of the Rx 112 determines the compensation value for the frequency compensation (see the optimization subroutine in FIG. 7) and terminates processing of the present processing flow. The determined compensation value mainly compensates for the frequency characteristics of the Rx 112.

FIG. 7 illustrates an optimization subroutine of the processing for designing the optical transmission system 1. The optimization subroutine is triggered and performed in step S14 or step S17 of FIG. 6.

First, the frequency characteristics of an individual module itself are obtained by offline means and are used as an initial value (step S101).

In step S102, a bit error rate (BER) of the signal is acquired.

In step S103, it is determined whether the BER satisfies a predetermined reference value (see FIG. 8).

When the BER satisfies the predetermined reference value (S103: Yes), the routine is terminated, and the processing returns to step S14 or step S17 of FIG. 6.

When the BER does not satisfy the predetermined reference value (S103: No), the compensation value for the frequency characteristics is changed in step S104, and the processing returns to step S102.

FIG. 8 is an explanatory diagram illustrating a relationship between the BER and the reference value. The horizontal axis represents the frequency characteristics compensation value, and the vertical axis represents the BER. In FIG. 8, a reference numeral a1 indicates an initial value, a reference numeral a2 indicates a subsequent state in which the frequency characteristics have been changed from the initial value, and a reference numeral a3 indicates a minimum value of the BER (reference value of the BER).

As shown in FIG. 8, the server 150 (see FIG. 1) records the BERs of some states where the frequency characteristics are changed. A state where the BER is the smallest is used as the reference value of the BER that is close to the optimum.

As described above, according to the present embodiment, the loopback is used to optimize each of the Tx and the Rx individually, and the compensation is completed in the transponder 110 alone. However, in practical use, a transponder is paired with a transponder of another premise, and thus, Tx and Rx are not always optimized as a whole.

### Second Embodiment

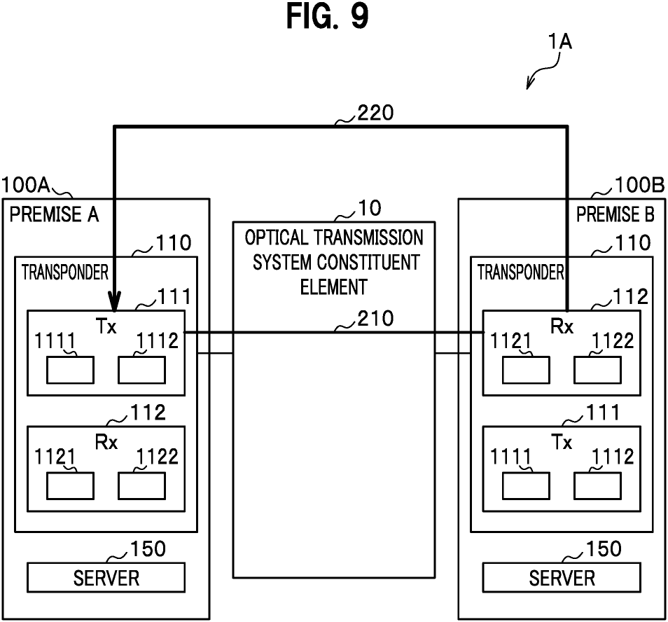

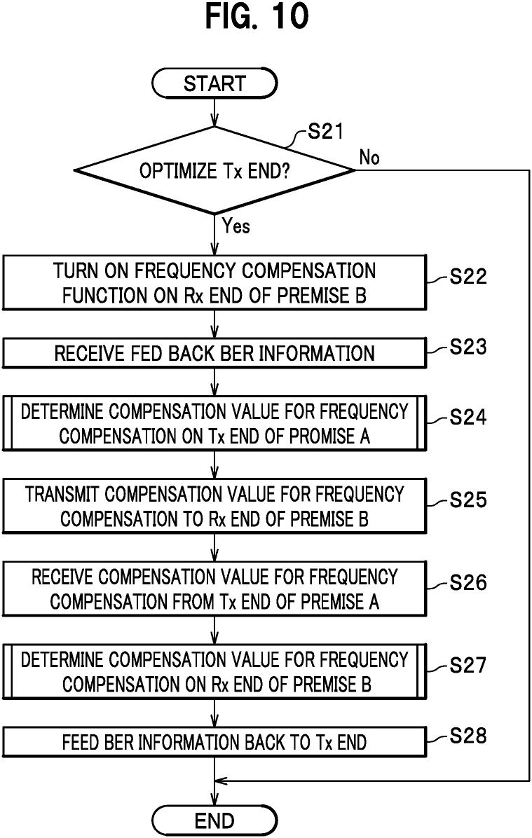

FIG. 9 is a diagram illustrating a configuration of an optical transmission system according to a second embodiment of the present disclosure. The same reference numerals are given to the same constituent parts as those in FIG. 1, and overlapping description is omitted.

As illustrated in FIG. 9, an optical transmission system 1A includes a premise 100A, a path 210 (a second path) passing through the optical transmission system constituent element 10 other than the transponder, an premise 100B connected to the premise 100A via the path 210, and a feedback path 220 to feed back BER information from the premise 100B to the premise 100A.

A method of designing the optical transmission system 1A configured as described above will be described below.

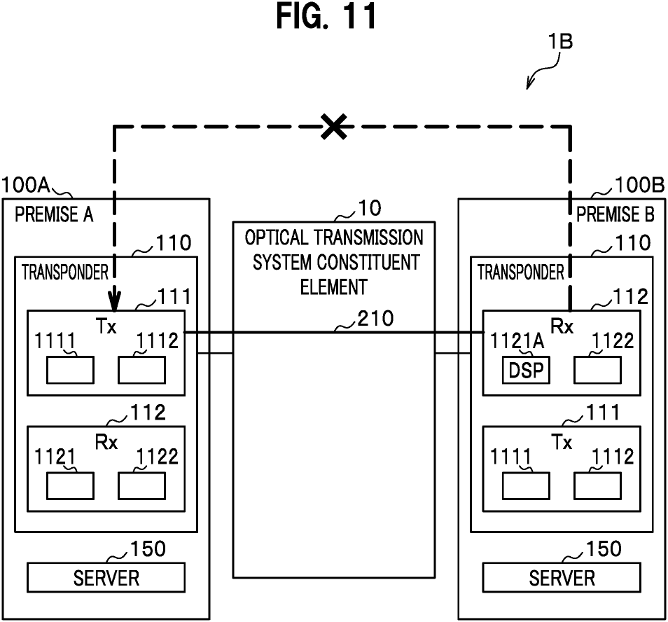

FIG. 10 is a flowchart illustrating processing for designing the optical transmission system 1A.

In step S21, it is determined whether optimization on the Tx 111 end is to be performed. When the optimization on the Tx 111 end is not to be performed, the processing of the present processing flow is terminated.

When the optimization on the Tx 111 end is to be performed, the function of the electric signal receiver 1121 (see FIG. 9) of the Rx 112 is turned on in step S22 (in this case, the compensation value remains at an initial value).

In step S23, the electric signal receiver 1121 of the Rx 112 of the premise 100A receives BER information fed back from the premise 100B to the premise 100A via the feedback path 220.

In step S24, the electric signal generator 1111 of the Tx 111 of the premise 100A determines the compensation value for the frequency compensation (see the optimization subroutine in FIG. 7). The determined compensation value mainly compensates for the frequency characteristics of the Tx 111.

Thus, a signal having opposite frequency characteristics (see FIG. 4) can be set as the compensation value for the frequency compensation.

In step S25, the electric signal transmitter 1112 of the Tx 111 of the premise 100B transmits the determined compensation value for the frequency compensation to the Rx 112 end.

In step S26, the electric signal receiver 1121 of the Rx 112 of the premise 100A receives the compensation value for the frequency compensation determined on the Tx 111 end.

In step S27, the electric signal generator 1122 of the Rx 112 of the premise 100B determines the compensation value for the frequency compensation (see the optimization subroutine in FIG. 7). Thus, the frequency characteristics of the Rx 112 are mainly compensated.

In step S28, the Rx 112 of the premise 100A feeds back the BER information to the Tx 111 of the premise 100A and terminates processing of the present processing flow.

As described above, according to the second embodiment, in order to optimize each of the Tx and the Rx individually, the transponders 110 of different premises are connected via the optical transmission system constituent element 10 other than the transponders 110, to compensate for the Tx and the Rx.

The second embodiment compensates for the frequency characteristics inherent in the optical transmission system constituent element 10 other than the transponders 110. Thus, in comparison to the first embodiment, when the transponders 110 that actually exchange a main signal are compensated as a pair, an effect of optimizing Tx and Rx as a whole is achieved.

### Third Embodiment

FIG. 11 is a diagram illustrating a configuration of an optical transmission system according to a third embodiment of the present disclosure. The same reference numerals are given to the same constituent parts as those in FIG. 9, and overlapping description is omitted.

As illustrated in FIG. 11, an optical transmission system 1B includes the premise 100A, the path 210 passing through the optical transmission system constituent element 10 other than the transponders, and the premise 100B connected to the premise 100A via the path 210.

The Rx 112 of the transponder 110 of the premise 100B includes, in place of the electric signal receiver 1121 of FIG. 9, an electric signal receiver 1121A including a DSP.

The electric signal receiver 1121A uses the DSP on the Rx end to optimize the frequency characteristics of the Tx and the Rx as a set.

A method of designing the optical transmission system 1B configured as described above will be described below.

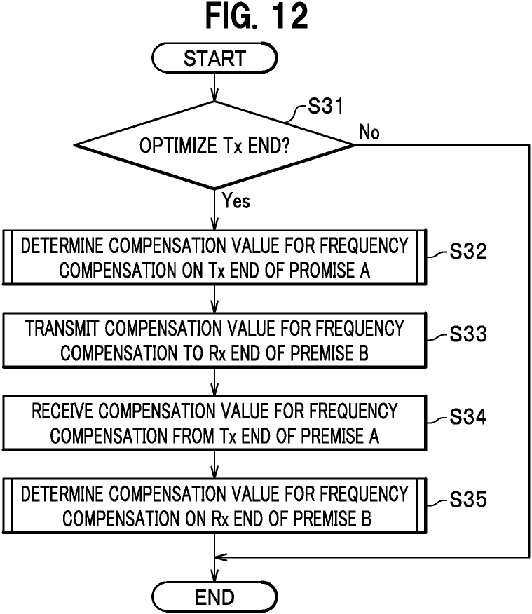

FIG. 12 is a flowchart illustrating processing for designing the optical transmission system 1B.

In step S31, it is determined whether optimization on the Tx 111 end is to be performed. When the optimization on the Tx 111 end is not to be performed, the processing of the present processing flow is terminated.

In step S32, the electric signal generator 1111 of the Tx 111 of the premise 100A determines the compensation value for the frequency compensation (see the optimization subroutine in FIG. 7). The determined compensation value mainly compensates for the frequency characteristics of the Tx 111.

Thus, a signal having opposite frequency characteristics (see FIG. 4) can be set as the compensation value for the frequency compensation.

In step S33, the electric signal transmitter 1112 of the Tx 111 of the premise 100B transmits the determined compensation value for the frequency compensation to the Rx 112 end via the loopback path 200.

In step S34, the electric signal receiver 1121A, which includes the DSP, of the Rx 112 of the premise 100A receives the compensation value for the frequency compensation determined on the Tx 111 end.

In step S35, the electric signal generator 1122 of the Rx 112 of the premise 100B determines the compensation value for the frequency compensation and terminates processing of the present processing flow (see the optimization subroutine in FIG. 7). Thus, the frequency characteristics of the Rx 112 are mainly corrected.

As described above, according to the third embodiment, the frequency characteristics of the Tx and the Rx are optimized as a set by the DSP of the electric signal receiver 1121A on the Rx end.

Compared with the first and second embodiments, the third embodiment does not include a processing flow in which either Tx or Rx is fixed (for example, the processing of step S22 in FIG. 10), and thus, the processing time can be reduced by about half.

Moreover, in the processing flow for optimizing the frequency characteristics, an effect is obtained in which the BER does not need to be fed back to the transmission end (for example, the processing of step S28 in FIG. 10).

### Fourth Embodiment

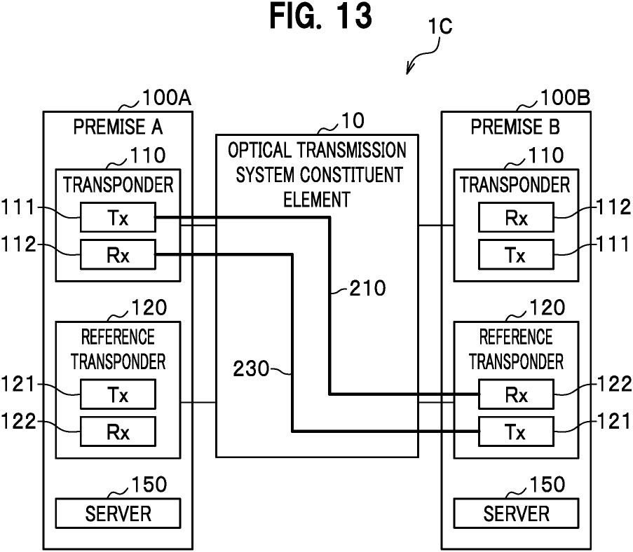

FIG. 13 is a diagram illustrating a configuration of an optical transmission system according to a fourth embodiment of the present disclosure. The same reference numerals are given to the same constituent parts as those in FIG. 9, and overlapping description is omitted.

As illustrated in FIG. 13, an optical transmission system 1C includes the premise 100A, paths 210 and 230 passing through the optical transmission system constituent element 10 other than the transponders, and the premise 100B connected to the premise 100A via the paths 210 and 230 (second paths).

In addition to the transponder 110 and the server 150, the premise 100A and the premise 100B each further include a reference transponder 120.

The reference transponder 120 outputs a frequency signal to be used as a reference for which frequency compensation has been performed.

The Tx 111 of the transponder 110 of the premise 100A is connected to the Rx 122 of the reference transponder 120 via the path 210. The Rx 112 of the transponder 110 of the premise 100A is connected to a Tx 121 of the reference transponder 120 via the path 230.

As described above, according to the fourth embodiment, in order to optimize each of the Tx and the Rx individually, the reference transponder 120 is connected to compensate for the Tx and the Rx. In the transponder 110 of the premise 100A, the Tx and the Rx can be compensated for simultaneously.

### Fifth Embodiment

FIG. 14 is a diagram illustrating a configuration of an optical transmission system according to a fifth embodiment of the present disclosure. The same reference numerals are given to the same constituent parts as those in FIG. 13, and overlapping description is omitted. Compensation on Tx End

As illustrated in FIG. 14, an optical transmission system 1D includes the premise 100A, the path 210 passing through the optical transmission system constituent element 10 other than the transponders, and the premise 100B connected to the premise 100A via the path 210.

In addition to the transponder 110 and the server 150, the premise 100B further includes a spectrum analyzer 130.

The spectrum analyzer 130 measures a frequency spectrum of the reception signal.

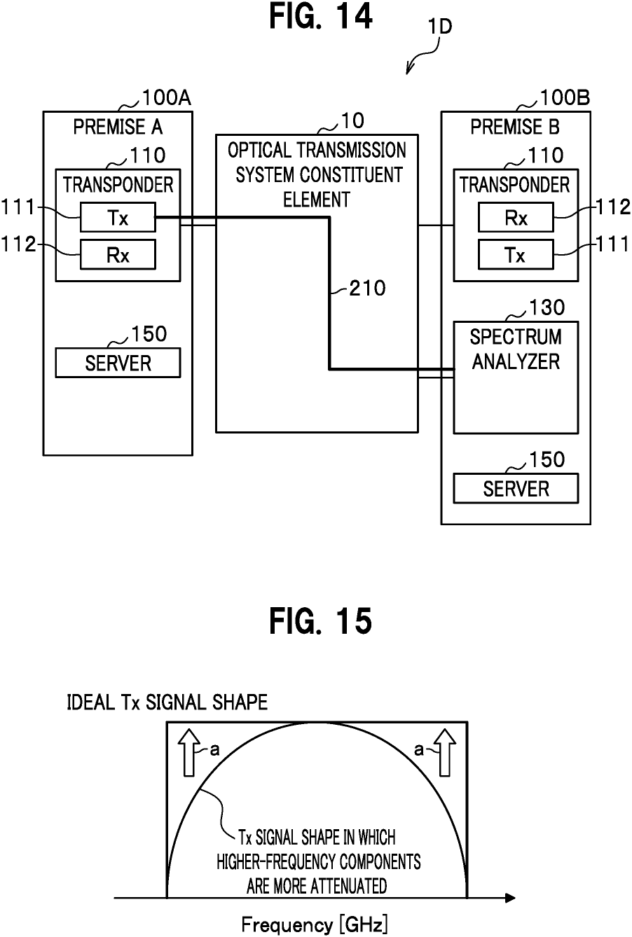

FIG. 15 is a graph illustrating an optical signal spectrum. The horizontal axis represents a frequency [GHz], and the vertical axis represents a frequency compensation amount.

As illustrated in FIG. 15, a signal transmitted through the optical transmission system constituent element 10 other than the transponders has a Tx signal shape in which higher-frequency components are attenuated, compared to an ideal Tx signal shape.

As shown by reference numerals a in FIG. 15, a Tx high-frequency component is compensated by the DSP.

As described above, according to the fifth embodiment, in “Compensation on Tx End”, instead of the BER, a result of the measurement of frequency spectrum by the spectrum analyzer 130 is utilized as means for compensating for the frequency characteristics on the Tx end.

In recent years, a small optical spectrum measurement module to be incorporated into an optical transmission system has been put into practical use. Degradation of signal bandwidth at higher frequencies means that the optical spectrum of the optical signal is not flat. The spectrum analyzer 130 measures a degree to which the optical spectrum is not flat, and the frequency characteristics on the Tx end are compensated for with the objective of flattening the result of the measurement with the spectrum analyzer 130. At this time, a data series of the optical signal on the transmission end may be changed to a data sequence giving a flat optical spectrum, instead of real data.

### Compensation on Rx End

FIG. 16 is a diagram illustrating a configuration of an optical transmission system according to a fifth embodiment of the present disclosure.

As illustrated in FIG. 16, an optical transmission system 1E includes the premise 100A, the path 210 passing through the optical transmission system constituent element 10 other than the transponders, and the premise 100B connected to the premise 100A via the path 210.

The spectrum analyzer 130 that branches the same optical power measures a frequency spectrum of the reception signal.

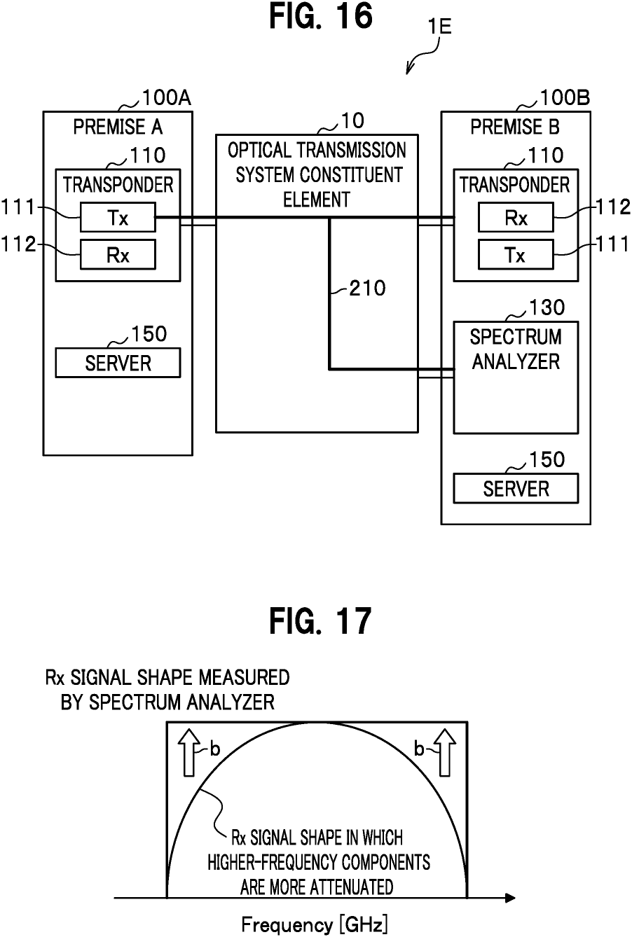

FIG. 17 is a graph showing an optical signal spectrum. The horizontal axis represents a frequency [GHz], and the vertical axis represents a frequency compensation amount.

As illustrated in FIG. 17, when a signal transmitted through the optical transmission system constituent element 10 other than the transponder is received, the received signal has an Rx signal shape in which higher-frequency components are attenuated, compared to an ideal Rx signal shape.

As shown by reference numerals b in FIG. 17, a Tx high-frequency component is compensated for by the DSP.

As described above, according to the fifth embodiment, in “Compensation on Rx end”, instead of the BER, a result of the measurement of the frequency spectrum by the spectrum analyzer 130 is utilized as means for compensating for the frequency characteristics on the Rx end.

In recent years, a small optical spectrum measurement module to be incorporated into an optical transmission system has been put into practical use. The frequency dependence of the spectrum analyzer 130 is typically sufficiently smaller than that of the frequency characteristics on the Rx end. The frequency characteristics on the Rx end are compensated for so as to approach the measurement result of the spectrum analyzer 130. In this case, output of the Tx signal from the transmission end may be stopped and an ASE noise generated in an optical amplification and relay device may be used (typically, a frequency flatness of a EDFA used in the optical amplification and relay device is flatter than the frequency characteristics of the electric modules of a transceiver).

### Effects

An effect of the optical transmission system and the like according to the present disclosure will be described below.

A transmission system 1 according to the present embodiment is the optical transmission system 1 including the transponder 110 having the transmitter 111 and the receiver 112 and is characterized by including the first path (loopback path 200) that directly couples a signal of the transmitter 111 to the receiver 112, and the calculation device (server 900) configured to calculate, based on a signal transmitted using the first path, a compensation value to compensate for the frequency characteristics of the signal transmitted from the transmitter.

With this configuration, the loopback is used to optimize each of Tx and Rx individually, and the compensation is completed in the transponder 110 alone. Thus, it is possible to optimally design the frequency compensation in the transponder.

Furthermore, the optical transmission system includes the first premise (premise 100A) on the transmission end including a transponder 110 and the second premise (premise 100B) on the reception end including a transponder 110 and is characterized in that the first premise and the second premise are connected via the second path (path 210), instead of the first path, passing through the optical transmission system constituent element other than the transponders.

With this configuration, the transponders 110 of different premises are connected and compensated for via the optical transmission system constituent element 10 other than the transponders 110. The frequency characteristics inherent in the optical transmission system constituent element 10 other than the transponders 110 are also compensated for. Thus, when the transponders 110 that actually exchange a main signal are compensated for as a pair, an effect of optimizing Tx and Rx as a whole is achieved.

Moreover, the optical transmission system is characterized in that a signal of the transmitter of the transponder of the first premise is received by the receiver of the transponder of the second premise via the second path (path 210), and a signal of the transmitter of the transponder of the second premise is received by the receiver of the transponder of the first premise via the second path (path 230).

With this configuration, the frequency characteristics inherent in the optical transmission system constituent element 10 other than the transponders 110 are also compensated for. Consequently, when the transponders 110 that actually exchange the main signal are corrected as a pair, an effect of optimizing Tx and Rx as a whole is achieved. This enables more optimal design of the frequency compensation.

Furthermore, the optical transmission system is characterized by including the feedback path 220 to feed back the BER information from the second premise to the first premise.

In this configuration, in the processing flow for optimizing the frequency characteristics, an effect is obtained in which the BER does not need to be fed back to the transmission end.

Furthermore, the optical transmission system includes the reference transponder 120 in the second premise and is characterized in that the calculation device calculates, based on a signal of the reference transponder 120, a compensation value to compensate for the frequency characteristics of the signal transmitted from the transmitter.

With this configuration, the frequency compensation can be designed more optimally by connecting the reference transponder 120 and performing compensation. Furthermore, in the transponder 110 of the premise 100A, Tx and Rx can be compensated simultaneously.

Furthermore, the optical transmission system includes the spectrum analyzer 130 in the second premise and is characterized in that the calculation device calculates, based on a result of the measurement with the spectrum analyzer 130, a compensation value to compensate for the frequency characteristics of the signal transmitted from the transmitter.

With this configuration, the result of the measurement of the frequency spectrum with the spectrum analyzer 130 may be employed instead of the BER. For example, the frequency characteristics on the Rx end are compensated for so as to approach the result of the measurement with the spectrum analyzer 130.

Note that, above embodiments are each described as an example applied to an optical transmission apparatus and an optical transmission system that employ devices and apparatuses for communication in a network using optical TDM technology represented by PON, for example. However, the embodiments may each be applied to any network system or any optical transmission apparatus in which a first optical transmission apparatus including an OLT as an optical line termination apparatus, the OLT terminating a signal transmitted and received to and from an external apparatus and serving as a controlling apparatus, and a plurality of second optical transmission apparatuses each including an ONU as an optical line termination apparatus to be controlled by the controlling apparatus, are connected in a ring shape by at least two optical transmission paths, and two identical pieces of data pass through the two optical transmission paths in opposite directions.

In addition, among the processing described in the embodiments, the entirety or a part of the processing described as being performed automatically can be manually performed, or the entirety or a part of the processing described as being performed manually can be performed automatically by known methods. In addition, information including the processing procedures, the control procedures, the specific names, and the various types of data and parameters described in the present document and drawings can be modified as desired unless otherwise specified.

Constituent elements of the devices illustrated in the drawings are functionally conceptual and are not necessarily physically configured as illustrated in the drawings. That is, the specific aspects of distribution and integration of each device are not limited to those illustrated in the drawings, and all or some of the devices may be distributed or integrated functionally or physically in desired units depending on various kinds of loads, states of use, and the like.

In addition, some or all of the configurations, the functions, the processing units, the processing mechanisms, and the like may be implemented in hardware by being designed, for example, in an integrated circuit. Each of the configurations, the functions, and the like may be implemented in software for a processor to interpret and execute a program that implements the functions. Information of programs, tables, files, and the like, which are for implementing the functions can be retained in a recording device such as a memory, a hard disk, and a solid state drive (SSD), or a recording medium such as an integrated circuit (IC) card, a secure digital (SD) card, and an optical disc.

### Reference Signs List

1A, 1B, 1C, 1D, 1E Optical transmission system
10 Optical transmission system constituent element other than transponders
100A Premise A (first premise)
100B Premise B (second premise)
110 Transponder
111 Transmitter (Tx)
112 Receiver (Rx)
113 Cross-connect function unit
120 Reference transponder
130 Spectrum analyzer
150 Server (calculation device)
200 Loopback path (first path)
210, 230 Path (second path) passing through optical transmission system constituent element other than transponder
220 Feedback path
1111 Electric signal generator
1112 Electric signal transmitter
1121, 1121A Electric signal receiver
1122 Electric signal generator

1-7. (canceled)

8. An optical transmission system including a transponder having a transmitter and a receiver, the optical transmission system comprising:
a first path configured to directly couple a signal of the transmitter to the receiver; and
a calculation device configured to calculate, based on a signal transmitted using the first path, a compensation value to compensate for frequency characteristics of a signal transmitted from the transmitter.

9. An optical transmission system comprising:
first and second premises each comprising a transponder comprising a transmitter and a receiver;
a first path connecting the transmitter of the transponder of the first premise to the receiver of the transponder of the second premise, the first path passing through an optical transmission path connecting between the first and second premises; and
a second path not passing through the optical transmission path and connecting the transponder of the first premise and the transponder of the second premise to feed back bit error rate information from the second premise to the first premise,
wherein the first premise further comprises a calculation device configured to calculate, based on the bit error rate information fed back through the second path, a compensation value to compensate for frequency characteristics of a signal transmitted from the transmitter of the transponder of the first premise.

10. An optical transmission system comprising:
a first premise comprising a transponder comprising a transmitter;
a second premise comprising a reference transponder comprising a receiver;
a path connecting the transmitter of the transponder of the first premise to the receiver of the reference transponder of the second premise, the path passing through an optical transmission path connecting between the first and second premises; and
wherein the optical transmission system is configured to calculate a compensation value to compensate for frequency characteristics of a signal transmitted from the transmitter of the transponder of the first premise, based on a signal of the reference transponder.

11. An optical transmission system comprising:
a first premise comprising a transponder comprising a transmitter;
a second premise comprising a spectrum analyzer;
a path connecting the transmitter of the transponder of the first premise to the spectrum analyzer of the second premise, the path passing through an optical transmission path connecting between the first and second premises;
wherein the optical transmission system is configured to calculate a compensation value to compensate for frequency characteristics of a signal transmitted from the transmitter of the transponder of the first premise, based on a result of a measurement by the spectrum analyzer.

12. A method of designing an optical transmission system comprising: a transponder including a transmitter and a receiver; and a first path configured to directly couple a signal of the transmitter to the receiver, the method comprising calculating, based on a signal transmitted using the first path, a compensation value to compensate for frequency characteristics of a signal transmitted from the transmitter.
